(19) United States
(12) Patent Application Publication
(10) Pub. No.: US 2003/0012482 A1
(43) Pub. Date: Jan. 16, 2003

(54) Optical-microwave-optical switching array for telecommunications

(76) Inventors: Jules D. Levine, Santa Clara, CA (US); Stan Freske, San Jose, CA (US); Ross A. LaRue, Milpitas, CA (US); Elim Chan, Sunnyvale, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/904,901

(22) Filed: Jul. 16, 2001

(51) Int. Cl. G02B 6/35; G02B 6/28; H04B 10/12

(52) U.S. Cl. 385/16; 385/24; 359/173

(57) ABSTRACT

A microwave switch array includes a first stack of N switch cards and a second stack of N switch cards, where N is an integer greater than 1, and an electrical connector between the two stacks. The second stack is positioned beneath the first stack. An angle of orientation of the second stack is substantially orthogonal to an angle of orientation of the first stack. The electrical connector is capable of transmitting signals within the microwave frequency range. Each of the N switch cards in the first stack may include an embedded 1×N signal splitter, and each of the N switch cards in the second stack may include an embedded N×1 signal combiner. Each of the N switch cards in the each stack may include both analog switching circuitry and digital control circuitry. Each of the N signal splitters may include a single semiconductor chip having a 1×N switch functionality, and each of the N signal combiners may include a single semiconductor chip having an N×1 switch functionality. The semiconductor chip may be mounted to a carrier, which may then be mounted to the respective card. Alternatively, each of the N signal splitters may include a plurality of semiconductor chips, where each chip has a 1×n switch functionality, and n is an integer greater than one. Similarly, each of the N signal combiners may include a plurality of semiconductor chips, where each chip has a n×1 switch functionality, and n is an integer greater than one. The value of n may vary from chip to chip. Each of the semiconductor chips may be mounted to a carrier, which may then be mounted to the card. The plurality of semiconductor chips may be arranged by centrally locating one of the chips and circumferentially locating the remainder of the chips about the one centrally located chip, such that radial symmetry of the arrangement is substantially optimized.

### BACKGROUND OF THE INVENTION

1. Field of the Invention

The present invention relates to an apparatus and a method for implementing a switching array for telecommunications, and more particularly to a switching array having optical inputs and optical outputs, and a microwave switch disposed between the inputs and the outputs.

2. Description of the Related Art

A basic optical-to-microwave-to-optical telecommunications system 100 is shown in FIG. 1. The system 100, which is described in U.S. patent application Ser. No. 09/727,171, filed on Nov. 29, 2000, and entitled “Crossconnect Switch With A Flat Frequency Response And A High Cutoff Frequency” and is incorporated herein by reference, comprises a network input 105, a demultiplexer 110, a photodetector 115, an N×N wideband switch 120, a laser and modulator 125, a multiplexer 130, and a network output 135.

An optical signal is transformed into a microwave signal at the photodetector 115, is passed into the microwave switch 120, and re-transformed back into an optical signal using the laser and modulator 125. The regenerating, reshaping, and retiming functions (3R) and their modifications, which may be carried out in the photodetector 115, the switch 120, and the modulator 125, are illustrated in FIG. 2.

In addition to the regeneration, reshaping, and retiming functions, there may be provided feedforward error correction circuits (not shown), which reduce the bit error rate (BER) of the system, and levelling circuits (also not shown) which can be used to flatten the frequency response of the switch to the frequency of the transmitted signal being passed through the switch.

The switch 120 is a microwave switch array, and it is used in a telecommunications system to switch optical signals. Each incoming optical signal is transformed to a microwave signal, switched in the microwave domain, and then transformed back to an outgoing optical signal. This switching system, known as optical-microwave-optical (OMO) or optical-millimeter wave-optical, is to be contrasted with other existing systems, such as all optical switching (OOO) or optical-electrical-optical (OEO) switching systems. In OEO systems, the bandwidth of each electrical unit is a small fraction of the optical bandwidth. In OMO systems, by contrast, the bandwidth of the electrical units is equal to the optical bandwidth.

The system 100, as described in U.S. patent application Ser. No. 09/727,171, involves a design in which two N×N switch plates are connected with N² via connections between them, as illustrated in FIG. 3. The N input rows are addressed from the left. Row #18 is shown explicitly. At point S1, a 1×N switch is used to direct the input row signal to any one of the N output column locations. A particular one of these is column 27, which is shown as point P. At point P, there is a via connecting this point on the input square with a similar point on the overlapping output square. Point P is connected through point S2 to the output column #27 by a N×1 switch located at point S2.

The array attained in practice using this design was an 8×8 switch array. However, there is a need for much larger array sizes, on the order of N=64 or more.

### SUMMARY OF THE INVENTION

The present invention addresses the need for a larger array size in a microwave switch array, while also recognizing the need for isolation to minimize crosstalk within the telecommunications system.

In one aspect, the invention provides a microwave switch array. The array includes a first stack of N switch cards and a second stack of N switch cards, where N is an integer greater than 1, and an electrical connector between the two stacks. The second stack is positioned beneath the first stack. An angle of orientation of the second stack is substantially orthogonal to an angle of orientation of the first stack. The electrical connector is capable of transmitting signals within the microwave frequency range. Each of the N switch cards in the first stack may include an embedded 1×N signal splitter, and each of the N switch cards in the second stack may include an embedded N×1 signal combiner.

The electrical connector may include a set of cables, where the cables are rated for transmission of microwave signals. Alternatively, the electrical connector may include mechanical fasteners, including cylindrical plugs which fit securely into screw-in connectors that are associated with each of the two stacks. The mechanical fasteners may include Gilbert connectors, which are capable of transmitting electrical signals having frequencies less than or equal to approximately 40 GHz, and for which the minimum pitch between two adjacent Gilbert connectors is approximately 0.17 inches.

Each of the N switch cards in the each stack may include both analog switching circuitry and digital control circuitry. The digital control circuitry may include either field programmable gate arrays (FPGA) or programmable logic devices (PLD).

Each of the N signal splitters may include a single semiconductor chip having a 1×N switch functionality. The semiconductor chip may be mounted to a carrier, which may then be mounted to each card in the first stack. Each of the N switch cards in the first stack may be manufactured using either organic materials, such as polyethylene, or ceramic materials. Each of the N signal combiners may include a single semiconductor chip having an N×1 switch functionality. Again, the semiconductor chip may be mounted to a carrier, which may then be mounted to each card in the second stack. Each of the N switch cards in the second stack may be manufactured using either organic or ceramic materials.

Alternatively, each of the N signal splitters may include a plurality of semiconductor chips, where each chip has a 1×n switch functionality, and n is an integer greater than one. The value of n may vary from chip to chip. Each of the semiconductor chips may be mounted to a carrier, which may then be mounted to the card. The plurality of semiconductor chips may be arranged by centrally locating one of the chips and circumferentially locating the remainder of the chips about the one centrally located chip, such that radial symmetry of the arrangement is substantially optimized. The carrier may include alumina.

Similarly, each of the N signal combiners may include a plurality of semiconductor chips, where each chip has a n×1 switch functionality, and n is an integer greater than one. The value of n may vary from chip to chip. Each of the semiconductor chips may be mounted to a carrier, which may then be mounted to the card. The plurality of semiconductor chips may be arranged by centrally locating one of the chips and circumferentially locating the remainder of the chips about the one centrally located chip, such that radial symmetry of the arrangement is substantially optimized. The carrier may include alumina.

In another aspect, a telecommunications system is provided. The system includes a receiver, a demultiplexer, a photodetector, a microwave switch array as described above, a laser and modulator, a multiplexer, and a transmitter. The receiver is configured to receive input signals at optical frequencies. The photodetector is configured to transform an optical signal into a microwave signal. The laser and modulator are configured to transform a microwave signal into an optical signal. The transmitter is configured to output signals at optical frequencies. The system may also include a signal regenerator, a signal reshaper, a signal retimer, and a forward error correction unit.

In yet another aspect, the invention provides an apparatus for increasing array size and reducing crosstalk in a telecommunications system, including array means for switching microwave signals. The array means includes means for accepting an input signal using a first stack of N switch cards, where N is an integer greater than 1, means for switching a signal, means for outputting a switched signal using a second stack of N switch cards, and means for electrically connecting the first stack to the second stack to allow transmission of signals within the microwave frequency range. The second stack is positioned beneath the first stack such that an angle of orientation of the second stack is substantially orthogonal to an angle of orientation of the first stack. The means for switching a signal may include means for splitting an input signal by using a 1×N signal splitter embedded into each of the N switch cards in the first stack and means for combining signals transmitted to the second stack via the means for electrically connecting by using an N×1 combiner embedded into each of the N switch cards in the second stack.

The means for electrically connecting the first stack to the second stack may include a set of cables, where the cables are rated for transmission of microwave signals. Alternatively, the means for electrically connecting the first stack to the second stack may include mechanical fasteners, including a plurality of cylindrical plugs which fit securely into a plurality of screw-in connectors which are associated with each of the two stacks. The mechanical fasteners may include Gilbert connectors that are capable of transmitting electrical signals having frequencies less than or equal to approximately 40 GHz, and for which the minimum pitch between two adjacent Gilbert connectors is approximately 0.17 inches.

Each of the switch cards in each stack may include both means for analog switching and means for digital control. The means for digital control may include either field programmable gate array (FPGA) or programmable logic device (PLD).

Each of the means for splitting may include a single semiconductor chip having a 1×N switch functionality. Each semiconductor chip may be mounted to a carrier means, which may then be mounted to each card in the first stack. Each of the N switch cards in the first stack may be manufactured using either organic materials, such as polyethylene, or ceramic materials. Likewise, each of the means for combining may include a single semiconductor chip having an N×1 switch functionality. Each semiconductor chip may be mounted to a carrier means, which may then be mounted to each card in the second stack. Each of the N switch cards in the first stack may be manufactured using either organic or ceramic materials.

Alternatively, each of the means for splitting may include a plurality of semiconductor chips, where each chip has a 1×n switch functionality, and n is an integer greater than one. The value of n may vary from chip to chip. Each of the semiconductor chips may be mounted to a carrier means, which may then be mounted to the card. The array means may further include means for reducing loss and reflections in an arrangement of the semiconductor chips by centrally locating one of the chips and circumferentially locating the remainder of the chips about the one centrally located chip such that radial symmetry is substantially optimized. The carrier means may include alumina.

Similarly, each of the means for combining may include a plurality of semiconductor chips, where each chip has a n×1 switch functionality, and n is an integer greater than one. The value of n may vary from chip to chip. Each of the semiconductor chips may be mounted to a carrier means, which may then be mounted to the card. The array means may further include means for reducing loss and reflections in an arrangement of the semiconductor chips by centrally locating one of the chips and circumferentially locating the remainder of the chips about the one centrally located chip such that radial symmetry is substantially optimized. The carrier means may include alumina.

In still another aspect of the invention, an apparatus for increasing microwave switch array size and reducing crosstalk in a telecommunications system is provided. The apparatus includes a means for receiving an input optical signal, a means for demultiplexing the received optical signal, a means for photodetecting the demultiplexed optical signal such that the signal is transformed from being an optical signal into being a microwave signal, a means for processing the signal with a microwave switch array using the apparatus described above, a means for modulating the signal such that the signal is transformed from being a microwave signal into being an optical signal, a means for multiplexing the optical signal, and a means for transmitting the optical signal. The apparatus may also include a means for regenerating the signal, a means for reshaping the signal, a means for retiming the signal, and a means for forward error correction.

In another aspect of the invention, a method of increasing array size and reducing cross-talk in a microwave switch array is provided. The method includes the steps of arranging a first stack of N switch cards, where N is an integer greater than 1; arranging a second stack of N switch cards such that the second stack is positioned beneath the first stack, and such that an angle of orientation of the second stack is substantially orthogonal to an angle of orientation of the first stack; and electrically connecting the first stack to the second stack to allow transmission of signals within the microwave frequency range. The method may also include the steps of enabling each of the N switch cards in the first stack to accept input signals by using a 1×N signal splitter, such that each input signal is accepted by one of the N switch cards in the first stack; splitting each input signal into N outputs, wherein each of the N splitter outputs is associated with one of the N switch cards in the second stack; enabling each of the N switch cards in the second stack to accept an output from each of the N splitters by using an N×1 combiner; and combining the combiner inputs into a single output for each input signal.

The step of electrically connecting the first stack to the second stack may include using a set of cables, where the cables are rated for transmission of microwave signals. Alternatively, the step of electrically connecting the first stack to the second stack may include using mechanical fasteners, including cylindrical plugs that fit securely into screw-in connectors that are associated with each of the two stacks. The mechanical fasteners may include Gilbert connectors, which are capable of transmitting electrical signals having frequencies less than or equal to approximately 40 GHz, and for which the minimum pitch between two adjacent Gilbert connectors is approximately 0.17 inches.

Each of the switch cards in each stack may include both analog switching circuitry and digital control circuitry. The digital control circuitry may include either field programmable gate array (FPGA) or programmable logic device (PLD).

Each of the N signal splitters may include a single semiconductor chip having a 1×N switch functionality. Each semiconductor chip may be mounted to a carrier, which then may be mounted to each card in the first stack. Likewise, each of the N signal combiners may include a single semiconductor chip having an N×1 switch functionality. Each semiconductor chip may be mounted to a carrier, which then may be mounted to each card in the second stack.

Alternatively, each of the N signal splitters comprises a plurality of semiconductor chips, where each chip has a 1×n switch functionality, and n is an integer greater than one. The value of n may vary from chip to chip. Each of the semiconductor chips may be mounted to a carrier, which may then be mounted to the card. The method may further include the steps of centrally locating one of the chips and circumferentially locating the remainder of the chips about the one centrally located chip such that radial symmetry of the arrangement is substantially optimized.

Similarly, each of the N signal combiners may include a plurality of semiconductor chips, where each chip has a n×1 switch functionality, and n is an integer greater than one. The value of n may vary from chip to chip. Each of the plurality of semiconductor chips may be mounted to a carrier, which then may be mounted to the card. The method may further include the steps of centrally locating one of the chips and circumferentially locating the remainder of the chips about the one centrally located chip such that radial symmetry of the arrangement is substantially optimized.

In yet another aspect of the invention, a method of increasing microwave switch array size and reducing crosstalk in a telecommunications system is provided. The method includes the steps of receiving an input optical signal, demultiplexing the received optical signal, photodetecting the demultiplexed optical signal such that the signal is transformed from being an optical signal into being a microwave signal, processing the signal with a microwave switch array using the method described above, modulating the signal such that the signal is transformed from being a microwave signal into being an optical signal, multiplexing the optical signal, and transmitting the optical signal. The method may further include the steps of regenerating the signal, reshaping the signal, retiming the signal, and making forward error corrections to the signal.

### BRIEF DESCRIPTION OF THE DRAWINGS

FIG. 1 is a block diagram of an optical-microwave-optical telecommunications system.

FIG. 2 is an illustration of the layout of the system of FIG. 1, including reshaping and retiming circuitry.

FIG. 3 is an illustration of the use of a 1×N switch to direct an input signal to an output that uses an N×1 switch.

FIG. 4 is an illustration of an arrangement of a double stack of switch cards, one stack functioning as a 1×N input switch array and the other stack functioning as an N×1 output switch array, according to an embodiment of the present invention.

FIGS. 5A and 5B are two cross-sectional views of the switch arrays of FIG. 4.

FIG. 6 is an illustration of a microwave interconnection between the two switch arrays of FIG. 4.

FIG. 7 is an illustration of a rigid mechanical interconnection between the two switch arrays of FIG. 4.

FIG. 8 is an illustration of a single-chip-on-card method of implementing a 1×N switch, according to an embodiment of the present invention.

FIG. 9 is an illustration of a multiple-chip-on-card method of implementing a 1×N switch, according to an embodiment of the present invention.

FIG. 10 is a schematic diagram of a 1×64 switch card.

### DETAILED DESCRIPTION OF THE INVENTION

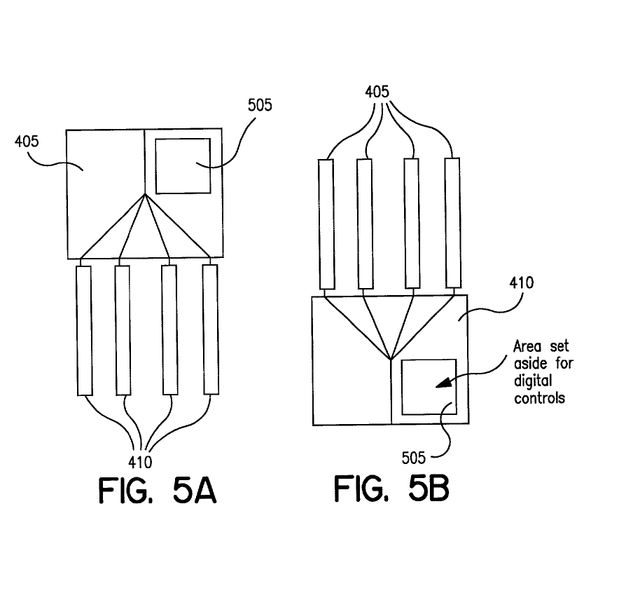

To improve on array size, the present inventors have developed a new design 400 involving a three-dimensional stacking as shown in FIG. 4. Two simplified cross-sectional views of the design of FIG. 4 are shown in FIGS. 5A and 5B.

Referring to FIGS. 4, 5A, and 5B, the unit comprises a multiplicity of switch cards of two types. A switch card in the upper block is oriented in the X direction and a switch card in the lower block is oriented in the Y direction. The assembly of switch cards 405 in the upper block is oriented at right angles to the switch cards 410 of the lower block. Each switch card has an array of 1×N switches. For the switch cards in the upper block, the switches fan out downwards, and for the switch cards in the lower block, the switches fan out upwards. All of the switch cards may be identical, except for their orientations: X, Y, upwards or downwards. Preferably, each card is approximately 2″×11″ in size.

A signal entering a top input of one of the switch cards 405 in the upper stack passes through an embedded 1×N splitter switch into one of N output locations at the base of the switch card 405. A signal entering a top input of one of the switch cards 410 in the lower stack passes through an embedded N×1 combiner switch into the output locations at the base of the switch card. By virtue of this structural design, where each card 405 has a single input, and each card 410 has a single output, any signal passing from any one of the N outputs in the upper stack can be passed to any of the N inputs in the lower stack. This is called an N×N switch. The purpose of the N×1 switch in the lower stack is to collect the N switch signals into one, with a minimum of reflection loss and with a maximum of isolation between switch inputs and outputs.

In each card, a portion 505 of the card surface may be allocated for digital controls, because the combination of analog switches and digital controls is helpful for proper operation of the switches. In FIGS. 5A and 5B, this control area 505 is schematically shown as a gray square. The purpose of the digital control is to activate a signal path from one of the inputs to one of the multiple outputs. The digital control can be complex if there are many switches in series. Examples of such control logic and circuitry include field-programmable-gate-arrays (FPGA), programmable-logic-devices (PLD), and others known in the art.

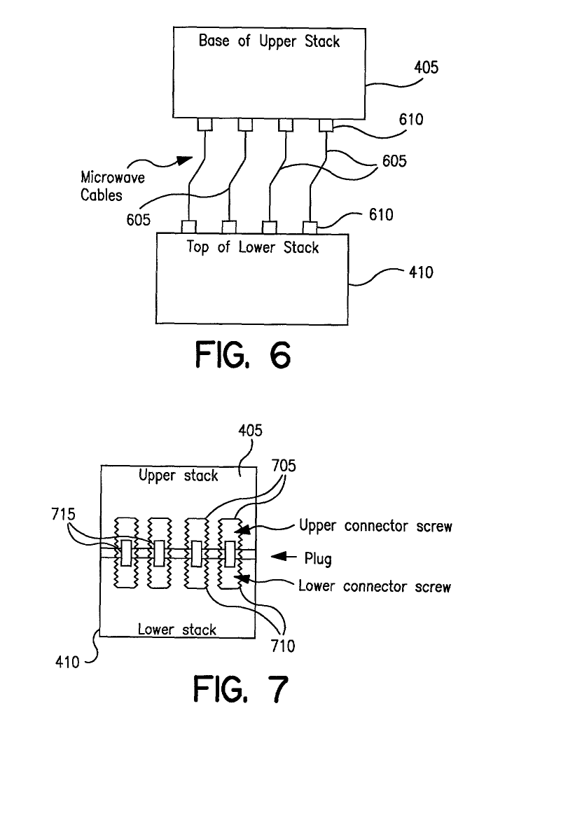

As may be seen in FIGS. 4, 5A, and 5B, signal lines from the upper stack are connected to those of the lower stack. This can be accomplished in several ways. In a first way, the signals are coupled using microwave cables 605, as shown in FIG. 6. The cables may be flexible or semi-rigid microwave cables. At the end of each cable is a cable screw connection 610, shown as a black square in the figure. At this site, a male cable is attached to a female housing, or vice versa. Preferably, each signal line is terminated at the edge of the switch card with a fixed cable termination that is acceptable for the frequency of interest. For example, cables rated for 40 GHz can be used for 40 GB/s analog signals. Each signal from a selected output of an 1×N switch card in the upper stack is directed into an N×1 switch card in the lower stack.

Referring to FIG. 7, another method of interconnection is shown. This method involves mechanical microwave feedthroughs that have three parts. The upper part is a screw-in connector into a cylindrical cavity 705 in the upper stack. When in position, this part has a cylindrical cavity facing downwards. The lower part is a screw-in connector into a cylindrical cavity 710 in the lower stack. When in position, this part has a cylindrical cavity facing upwards. The middle part is a cylindrical plug 715 which has a close tolerance to each of the cavities described above. This unit can be assembled as a press fit. Preferably, cavities 705 and 710 each have a diameter of approximately 0.14 inches. Parts similar to those shown in FIG. 7 can be obtained commercially from Gilbert Company with an ability to pass microwave signals from 0 to 40 GHz with minimal loss. The minimum pitch available today between two adjacent Gilbert connectors is 0.17 inches.

Referring again to FIG. 4, one advantage of this type of switch array, as compared to a crosspoint switch array, is that the array of FIG. 4 disposes two switches in series. This greatly improves the overall isolation of the system. For example, if the isolation of one switch is 30 dB, the isolation of two switches in series is 60 dB. Increased isolation is very important for reducing crosstalk.

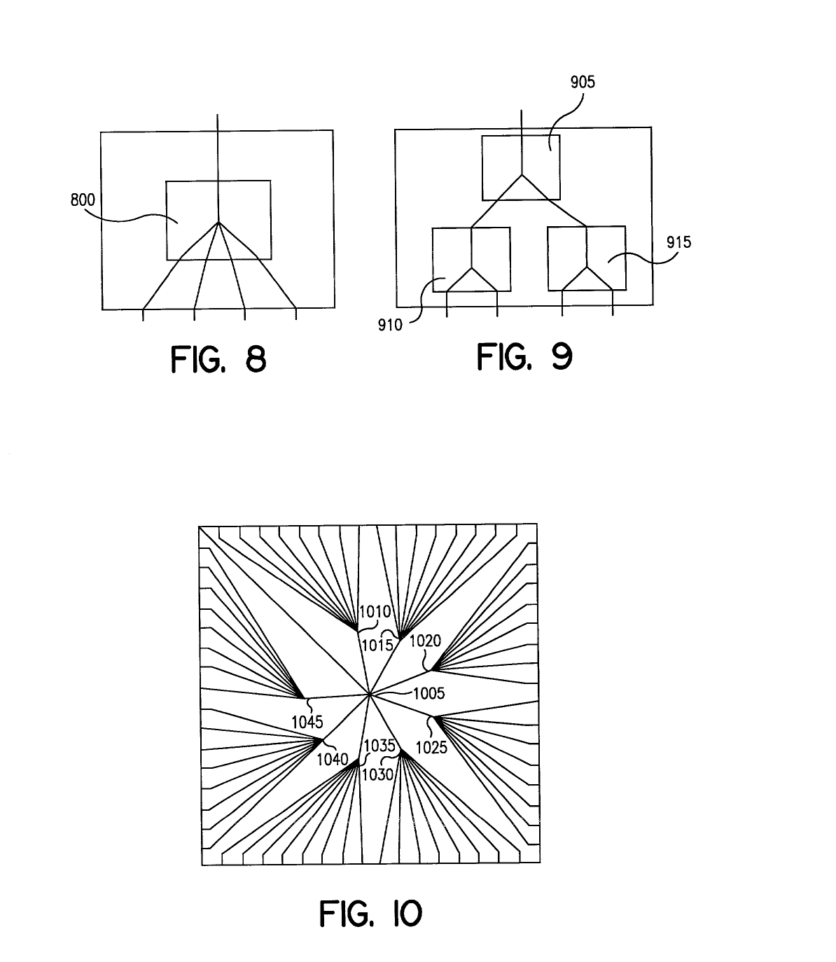

Switch cards can be assembled with single 1×N switches 800, as shown in FIG. 8. In the single chip-on-board method of FIG. 8, a single chip with full functionality may be attached to a card of much larger dimension. In the case of FIG. 8, N=4, and this corresponds to a 4×1 (or 1×4) switch. The card can be made of an organic material such as polyethylene, a ceramic material such as alumina, or any other material known in printed circuit board technology. The wiring on the card is standard, and the mounting techniques used for mounting the chip to the card are standard. It is usual at high frequencies that the chip is mounted to a carrier and the carrier is mounted to the card, but this carrier is not shown in FIG. 8, because the functional relationship between the chip and card are unchanged by the presence of a carrier.

In the multiple chip-on-board design of FIG. 9, many chips of subordinate functionality are assembled to a card of much larger dimension. In this figure, three chips 905, 910, 915 with 2×1 functionality are assembled to yield the desired 4×1 functionality. An advantage of the multiple chip-on-board design is that the crosstalk between neighboring signal paths is reduced compared to that of the single chip-on-board design, because they are spatially separated to a greater extent. Another advantage of the multiple chip-on-board design is that the package design can be utilized to minimize the reflection between adjacent chips, rather than doing this on the single chip level, which is more restricted due to space limitations on the single chip.

Referring to FIG. 10, in an exemplary embodiment of the multiple chip-on-board design, nine 1×8 chips are bonded to an alumina carrier, which is then bonded onto a card to yield a 1×64 functionality having a frequency response of up to 40 GHz. In this example, there is one 1×8 central switch 1005, and eight 1×8 switches 1010, 1015, 1020, 1025, 1030, 1035, 1040, 1045 arranged circumferentially about the central chip. At the periphery, there are 64 output signal lines. The input line to the central switch is located at the upper left corner.

The radial symmetry of the design of FIG. 10 provides an advantage in equalizing the various path lengths between the eight circumferential 1×N chips. Undesirable coupling between adjacent lines is also minimized by the radial design. Such designs enable various combinations of upper and lower stacks, side-to-side stacks, and even combinations of upper-lower-side-to-side stacks.

The preferred Gilbert connectors have a pitch of 0.17″, which creates a limitation in packing density of about 6 cards/inch. Another limitation is chip or package height, which is presently approximately 0.035 inches. When included with a preferred board thickness of approximately 0.055 inches, the total height may be approximately equal to 0.090 inches. This yields a packing density limitation due to this factor of about 11 cards/inch. It is desirable to maximize the card packing density and overall card size to yield as compact a product as possible.

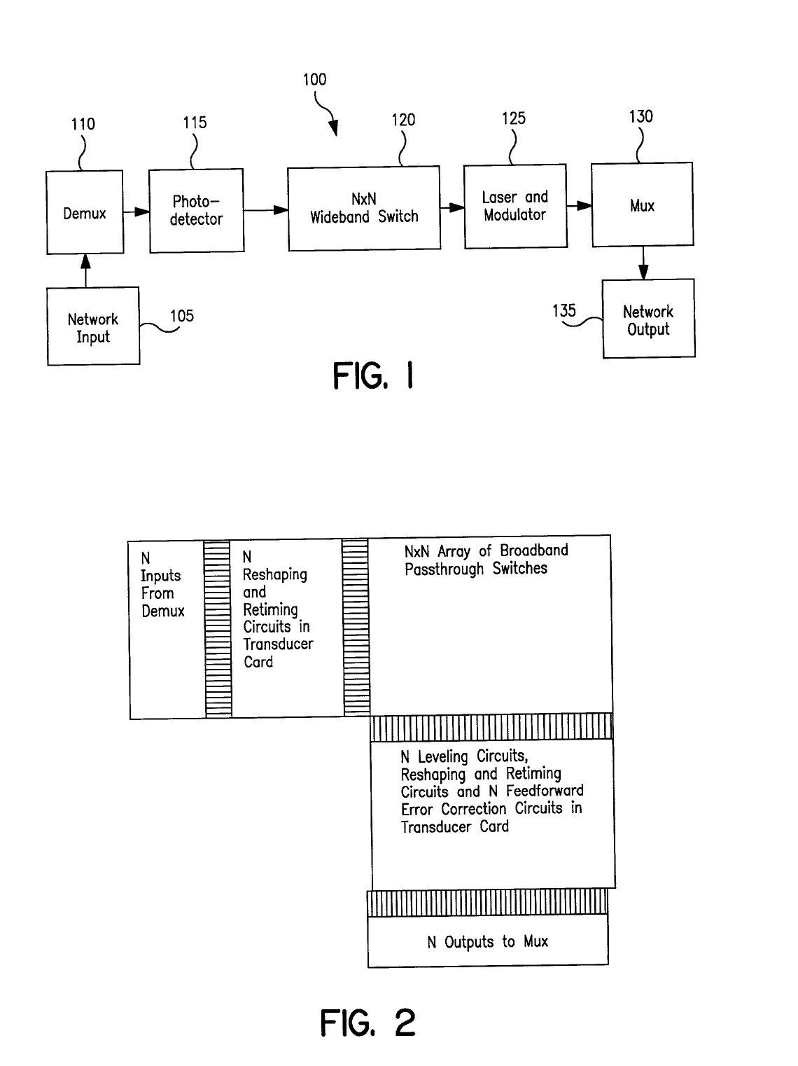

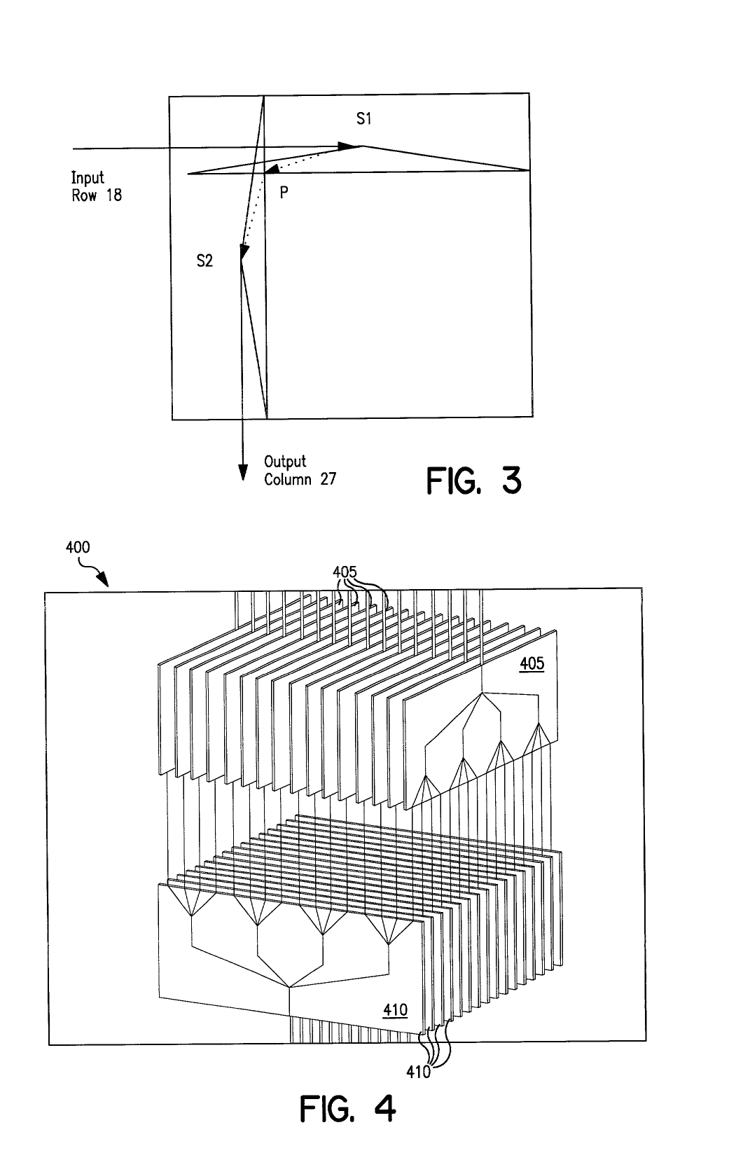

Experimental results arising from a test using a 16×16 switch array according to the present above-described preferred embodiment are presented herein. The switch array was tested using OC48 signals rated at 2.5 GB/s. The switch was rated only to 2.5 GHz, after which the insertion loss decreases significantly. The isolation was excellent and broadband: −60 dB at 1 GHz and −45 dB at 15 GHz. The insertion loss was −5 dB at DC, and fell to −15 dB at 2.5 GHz. Nevertheless, when the signals were passed through a regenerating, reshaping, and retiming grooming circuit at the edge of the switch (as shown in FIG. 2), then the error rate was very small. In one test, the system was run for three days with no bit errors found, thus resulting in an upper bound of bit error rate (BER) in the range of 10⁻¹⁵.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. For example, it is to be understood that the invention is applicable to a multiple chip-on-board design in which the switch sizes vary from chip to chip; e.g., N=32, using a central chip having a 1×8 switch and eight circumferentially arranged chips having 1×4 switches, for a total 1×32 switch functionality. As another example, the invention is applicable to an N×M switch, where N≠M, and the number of cards in the upper stack is N, and the number of cards in the lower stack is M. The scope of the following claims is to be accorded the broadest interpretation so as to encompass all such modifications and equivalent structures and functions.

What is claimed is:

1. A microwave switch array, comprising:
a first stack of N switch cards, N being an integer greater than 1;
a second stack of at least N switch cards, the second stack being disposed substantially orthogonal to the first stack; and
an electrical connector disposed between the first stack and the second stack, the electrical connector being capable of transmitting signals within the microwave frequency range.

2. The microwave switch array of claim 1, wherein each of the N switch cards in the first stack includes an embedded 1×N signal splitter, and wherein each of the N switch cards in the second stack includes an embedded N×1 signal combiner.

3. The microwave switch array of claim 2, wherein the electrical connector comprises a plurality of cables, each cable being rated for transmission of microwave signals.

4. The microwave switch array of claim 2, wherein the electrical connector comprises mechanical fasteners,
the mechanical fasteners including a plurality of cylindrical plugs, a plurality of first screw-in connectors, and a plurality of second screw-in connectors,
the first screw-in connectors being associated with the first stack, and the second screw-in connectors being associated with the second stack, and
the plugs being configured to fit securely into the first and second screw-in connectors.

5. The microwave switch array of claim 4, the mechanical fasteners comprising Gilbert connectors, the Gilbert connectors being capable of transmitting electrical signals having frequencies less than or equal to approximately 40 GHz, and the minimum pitch between two adjacent Gilbert connectors being approximately 0.17 inches.

6. The microwave switch array of claim 2, each of the N switch cards in the first stack and each of the at least N switch cards in the second stack including both analog switching circuitry and digital control circuitry.

7. The microwave switch array of claim 6, the digital control circuitry comprising a field programmable gate array (FPGA).

8. The microwave switch array of claim 6, the digital control circuitry comprising a programmable logic device (PLD).

9. The microwave switch array of claim 2, each of the N signal splitters comprising a single semiconductor chip having a 1×N switch functionality.

10. The microwave switch array of claim 9, each of the N switch cards in the first stack comprising a carrier, wherein for each card, the semiconductor chip is mounted to the carrier and the carrier is mounted to the card.

11. The microwave switch array of claim 10, wherein each of the N switch cards in the first stack comprises an organic material.

12. The microwave switch array of claim 11, wherein the organic material comprises polyethylene.

13. The microwave switch array of claim 10, wherein each of the N switch cards in the first stack comprises a ceramic material.

14. The microwave switch array of claim 13, wherein the ceramic material comprises alumina.

15. The microwave switch array of claim 2, each of the at least N signal combiners comprising a single semiconductor chip having an N×1 switch functionality.

16. The microwave switch array of claim 15, each of the at least N switch cards in the second stack comprising a carrier, wherein for each card, the semiconductor chip is mounted to the carrier and the carrier is mounted to the card.

17. The microwave switch array of claim 16, wherein each of the at least N switch cards in the second stack comprises an organic material.

18. The microwave switch array of claim 17, wherein the organic material comprises polyethylene.

19. The microwave switch array of claim 16, wherein each of the at least N switch cards in the second stack comprises a ceramic material.

20. The microwave switch array of claim 19, wherein the ceramic material comprises alumina.

21. The microwave switch array of claim 2, each of the N signal splitters comprising a plurality of semiconductor chips, each chip having a 1×n switch functionality, wherein n is an integer greater than one, and the value of n may vary from chip to chip.

22. The microwave switch array of claim 21, each of the N switch cards in the first stack comprising a carrier, wherein for each card, each of the plurality of semiconductor chips is mounted to the carrier and the carrier is mounted to the card.

23. The microwave switch array of claim 22, the plurality of semiconductor chips being arranged by centrally locating one of the plurality of semiconductor chips and circumferentially locating the remainder of the plurality of semiconductor chips about the one centrally located chip in a radial array.

24. The microwave switch array of claim 22, wherein the carrier comprises alumina.

25. The microwave switch array of claim 2, each of the at least N signal combiners comprising a plurality of semiconductor chips, each chip having a n×1 switch functionality, wherein n is an integer greater than one, and the value of n may vary from chip to chip.

26. The microwave switch array of claim 25, each of the at least N switch cards in the second stack comprising a carrier, wherein for each card, each of the plurality of semiconductor chips is mounted to the carrier and the carrier is mounted to the card.

27. The microwave switch array of claim 25, the plurality of semiconductor chips being arranged by centrally locating one of the plurality of semiconductor chips and circumferentially locating the remainder of the plurality of semiconductor chips about the one centrally located chip in a radial array.

28. The microwave switch array of claim 25, wherein the carrier comprises alumina.

29. A telecommunications system, comprising:
a receiver, the receiver being configured to receive input signals at optical frequencies;
a demultiplexer;
a photodetector, the photodetector being configured to transform an optical signal into a microwave signal;
the microwave switch array of claim 1;
a laser and modulator, the laser and modulator configured to transform a microwave signal into an optical signal;
a multiplexer; and
a transmitter, the transmitter being configured to output signals at optical frequencies.

30. The system of claim 29, further comprising:
a signal regenerator;
a signal reshaper; and
a signal retimer.

31. The system of claim 30, further comprising a forward error correction unit.

32. An apparatus for increasing array size and reducing crosstalk in a telecommunications system, the apparatus including array means for switching microwave signals, the array means comprising:
means for accepting an input signal using a first stack of N switch cards, N being an integer greater than 1;
means for switching a signal;
means for outputting a switched signal using a second stack of at least N switch cards, the second stack being disposed substantially orthogonal to the first stack; and
means for electrically connecting the first stack to the second stack to allow transmission of signals within the microwave frequency range.

33. The apparatus of claim 32, the means for switching a signal comprising:
means for splitting an input signal by using a 1×N signal splitter embedded into each of the N switch cards in the first stack; and
means for combining signals transmitted to the second stack via the means for electrically connecting by using an N×1 combiner embedded into each of the N switch cards in the second stack.

34. The apparatus of claim 33, wherein the means for electrically connecting the first stack to the second stack comprises a plurality of cables, each cable being rated for transmission of microwave signals.

35. The apparatus of claim 33, wherein the means for electrically connecting the first stack to the second stack comprises mechanical fasteners,
the mechanical fasteners including a plurality of cylindrical plugs, a plurality of first screw-in connectors, and a plurality of second screw-in connectors,
the first screw-in connectors being associated with the first stack, and the second screw-in connectors being associated with the second stack, and
the plugs being configured to fit securely into the first and second screw-in connectors.

36. The apparatus of claim 35, the mechanical fasteners comprising Gilbert connectors, the Gilbert connectors being capable of transmitting electrical signals having frequencies less than or equal to approximately 40 GHz, and the minimum pitch between two adjacent Gilbert connectors being approximately 0.17 inches.

37. The apparatus of claim 33, each of the N switch cards in the first stack and each of the at least N switch cards in the second stack including both means for analog switching and means for digital control.

38. The apparatus of claim 37, the means for digital control comprising a field programmable gate array (FPGA).

39. The apparatus of claim 37, the means for digital control comprising a programmable logic device (PLD).

40. The apparatus of claim 33, each of the means for splitting comprising a single semiconductor chip having a 1×N switch functionality.

41. The apparatus of claim 40, each of the N switch cards in the first stack comprising a carrier means, wherein for each card, the semiconductor chip is mounted to the carrier means, and the carrier means is mounted to the card.

42. The apparatus of claim 41, wherein each of the N switch cards in the first stack comprises an organic material.

43. The apparatus of claim 42, wherein the organic material comprises polyethylene.

44. The apparatus of claim 41, wherein each of the N switch cards in the first stack comprises a ceramic material.

45. The apparatus of claim 44, wherein the ceramic material comprises alumina.

46. The apparatus of claim 33, each of the means for combining comprising a single semiconductor chip having an N×1 switch functionality.

47. The apparatus of claim 46, each of the at least N switch cards in the second stack comprising a carrier means, wherein for each card, the semiconductor chip is mounted to the carrier means, and the carrier means is mounted to the card.

48. The apparatus of claim 47, wherein each of the at least N switch cards in the second stack comprises an organic material.

49. The apparatus of claim 48, wherein the organic material comprises polyethylene.

50. The apparatus of claim 47, wherein each of the at least N switch cards in the second stack comprises a ceramic material.

51. The apparatus of claim 50, wherein the ceramic material comprises alumina.

52. The apparatus of claim 33, each of the means for splitting comprising a plurality of semiconductor chips, each chip having a 1×n switch functionality, wherein n is an integer greater than one, and the value of n may vary from chip to chip.

53. The apparatus of claim 52, each of the N switch cards in the first stack comprising a carrier means, wherein for each card, each of the plurality of semiconductor chips is mounted to the carrier means, and the carrier means is mounted to the card.

54. The apparatus of claim 53, the array means further comprising means for reducing loss and reflections in an arrangement of the plurality of semiconductor chips by centrally locating one of the plurality of semiconductor chips and circumferentially locating the remainder of the plurality of semiconductor chips about the one centrally located chip in a radial array.

55. The apparatus of claim 53, wherein the carrier means comprises alumina.

56. The apparatus of claim 33, each of the means for combining comprising a plurality of semiconductor chips, each chip having a n×1 switch functionality, wherein n is an integer greater than one, and the value of n may vary from chip to chip.

57. The apparatus of claim 56, each of the at least N switch cards in the second stack comprising a carrier means, wherein for each card, each of the plurality of semiconductor chips is mounted to the carrier means, and the carrier means is mounted to the card.

58. The apparatus of claim 56, the array means further comprising means for reducing loss and reflections in an arrangement of the plurality of semiconductor chips by centrally locating one of the plurality of semiconductor chips and circumferentially locating the remainder of the plurality of semiconductor chips about the one centrally located chip in a radial array.

59. The apparatus of claim 56, wherein the carrier means comprises alumina.

60. An apparatus for increasing microwave switch array size and reducing cross-talk in a telecommunications system, the apparatus comprising:
means for receiving an input optical signal;
means for demultiplexing the received optical signal;
means for photodetecting the demultiplexed optical signal such that the signal is transformed from being an optical signal into being a microwave signal;
means for processing the signal with a microwave switch array using the apparatus of claim 32;
means for modulating the signal such that the signal is transformed from being a microwave signal into being an optical signal;
means for multiplexing the optical signal; and
means for transmitting the optical signal.

61. The apparatus of claim 60, further comprising:
means for regenerating the signal;
means for reshaping the signal; and
means for retiming the signal.

62. The apparatus of claim 61, further comprising forward error correction means for correcting errors.

63. A method of increasing array size and reducing crosstalk in a microwave switch array, the method comprising the steps of:
arranging a first stack of N switch cards, N being an integer greater than 1;
arranging a second stack of at least N switch cards such that the second stack is disposed substantially orthogonal to the first stack; and
electrically connecting the first stack to the second stack to allow transmission of signals within the microwave frequency range.

64. The method of claim 63, further comprising the steps of:
enabling each of the N switch cards in the first stack to accept input signals by using a 1×N signal splitter, such that each input signal is accepted by one of the N switch cards in the first stack;
splitting each input signal into N outputs, wherein each of the N splitter outputs is associated with one of the N switch cards in the second stack;
enabling each of the at least N switch cards in the second stack to accept an output from each of the N splitters by using an N×1 combiner; and
combining the combiner inputs into a single output for each input signal.

65. The method of claim 63, wherein the step of electrically connecting the first stack to the second stack comprises using a plurality of cables, each cable being rated for transmission of microwave signals.

66. The method of claim 64, wherein the step of electrically connecting the first stack to the second stack comprises using mechanical fasteners,
the mechanical fasteners including a plurality of cylindrical plugs, a plurality of first screw-in connectors, and a plurality of second screw-in connectors,
the first screw-in connectors being associated with the first stack, and the second screw-in connectors being associated with the second stack, and
the plugs being configured to fit securely into the first and second screw-in connectors.

67. The method of claim 66, the mechanical fasteners comprising Gilbert connectors, the Gilbert connectors being capable of transmitting electrical signals having frequencies less than or equal to approximately 40 GHz, and the minimum pitch between two adjacent Gilbert connectors being approximately 0.17 inches.

68. The method of claim 64, each of the N switch cards in the first stack and each of the at least N switch cards in the second stack including both analog switching circuitry and digital control circuitry.

69. The method of claim 68, the digital control circuitry comprising a field programmable gate array (FPGA).

70. The method of claim 68, the digital control circuitry comprising a programmable logic device (PLD).

71. The method of claim 64, each of the N signal splitters comprising a single semiconductor chip having a 1×N switch functionality.

72. The method of claim 71, each of the N switch cards in the first stack comprising a carrier, wherein for each card, the semiconductor chip is mounted to the carrier and the carrier is mounted to the card.

73. The method of claim 64, each of the at least N signal combiners comprising a single semiconductor chip having an N×1 switch functionality.

74. The method of claim 73, each of the at least N switch cards in the second stack comprising a carrier, wherein for each card, the semiconductor chip is mounted to the carrier and the carrier is mounted to the card.

75. The method of claim 64, each of the N signal splitters comprising a plurality of semiconductor chips, each chip having a 1×n switch functionality, wherein n is an integer greater than one, and the value of n may vary from chip to chip.

76. The method of claim 75, each of the N switch cards in the first stack comprising a carrier, wherein for each card, each of the plurality of semiconductor chips is mounted to the carrier and the carrier is mounted to the card.

77. The method of claim 76, further comprising the steps of:
centrally locating one of the plurality of semiconductor chips; and
circumferentially locating the remainder of the plurality of semiconductor chips about the one centrally located chip in a radial array.

78. The method of claim 74, each of the at least N signal combiners comprising a plurality of semiconductor chips, each chip having a n×1 switch functionality, wherein n is an integer greater than one, and the value of n may vary from chip to chip.

79. The method of claim 78, each of the at least N switch cards in the second stack comprising a carrier, wherein for each card, each of the plurality of semiconductor chips is mounted to the carrier and the carrier is mounted to the card.

80. The method of claim 78, further comprising the steps of:
centrally locating one of the plurality of semiconductor chips; and
circumferentially locating the remainder of the plurality of semiconductor chips about the one centrally located chip in a radial array.

81. A method of increasing microwave switch array size and reducing crosstalk in a telecommunications system, the method comprising the steps of:
receiving an input optical signal;
demultiplexing the received optical signal;
photodetecting the demultiplexed optical signal such that the signal is transformed from being an optical signal into being a microwave signal;
processing the signal with a microwave switch array using the method of claim 63;
modulating the signal such that the signal is transformed from being a microwave signal into being an optical signal;
multiplexing the optical signal; and
transmitting the optical signal.

82. The method of claim 81, further comprising the steps of:
regenerating the signal;
reshaping the signal; and
retiming the signal.

83. The method of claim 82, further comprising the step of correcting errors in the signal using a forward error correction unit.
